(19) United States
(12) Patent Application Publication
(10) Pub. No.: US 2004/0047453 A1
(43) Pub. Date: Mar. 11, 2004

(54) Variable automated response system

(76) Inventor: Norman MacAskill Fraser, Surrey (GB)

Correspondence Address: BIRCH STEWART KOLASCH & BIRCH, PO BOX 747, FALLS CHURCH, VA, 22040-0747, US

(21) Appl. No.: 10/381,845

(22) PCT Filed: Sep. 28, 2001
(86) PCT No.: PCT/GB01/04343

(30) Foreign Application Priority Data
Sep. 28, 2000 (GB) 0023834.5

(51) Int. Cl. H04M 11/00

(52) U.S. Cl. 379/88.18

(57) ABSTRACT

The variable automated response system enables use customisation of the interactions between the user and the system. The system includes a voice portal personalisation controller (1) incorporating a program memory (5) in which is stored a suite of programs for controlling the manner in which the customisation requirements of a user are obtained and recorded. The controller (1) is also the host server for the customisation pages a user accesses over the internet to define their chosen customisation. The system further includes an interactive voice response server (4) which has access to a scripts store (2) and a user profiles store (3). The interaction between a particular user and the interactive voice response (4), usually via telephone, is dynamic to the extent that the user prescribed customisation defines the desired interaction.

The present invention relates to a variable automated response system and to a method of varying the procedure of an automated response system. The present invention is particularly, but not exclusively, concerned with telephone-based interactive voice response systems.

Telephone-based interactive voice response systems have been developed to automate communication over the telephone where such communications have repeated features. Such a telephone-based interactive voice response (VR) system is usually implemented in a computer system which can be accessed by callers by means of a conventional telephone connected to a public switched telephone network (PSTN) or private branch exchange (PBX). IVR systems communicate with callers by means of pre-recorded or synthesised natural language utterances, which may be augmented with the use of recorded or generated tones, sound clips and/or music. Callers communicate with IVR systems by means of telephone touch tones, spoken words or natural language phrases (which can be processed using speech recognition technology, or recorded for later analysis).

For example, IVR systems exist which automate duties formerly the responsibility of a telephonist. On receipt of a telephone call such a system replays a pre-recorded message inviting the caller to identify the person they wish to be transferred to and often the pre-recorded message also indicates the valid options available. In reply, the caller states their selection which is speech recognised and, in response to the caller's stated selection, the caller is automatically transferred to the desired recipient. More complex IVR systems can lead a telephone caller through a hierarchy of selections. For example, information on films showing at a cinema and the times of the films can be obtained automatically using interactive voice response technology. To date, in all cases the ‘script’ followed by the IVR system is fixed and a caller must progress through the entire script in order to be connected to the person they wish to speak to or to obtain the information they require. For more complex hierarchical systems this can be extremely time-consuming and a frustrating experience for the caller.

The present invention seeks to provide an improved automated response system that enables a caller to control the interaction they have with the automated response system and in particular to select the information that is requested and provided by the automated response system.

The present invention provides a variable automated response system comprising a user interface; a forms store in which one or more forms to be displayed to a user are stored; a program memory containing instructions for recording data entered into one or more forms by a user via the user interface and for generating a user specific script in dependence on said recorded data a script store in which a plurality of user specific scripts are stored; and an interactive response system for accessing and reproducing audibly a script in dependence on the user accessing the interactive response system.

Preferably, a user profiles store is provided containing data on a plurality of users in relation to user identification data and script identification data. The user identification data may include a user's telephone number in which case the interactive response system may include caller identification means for identifying a caller by means of the telephone number they are calling from.

In a preferred embodiment the script store includes a default script from which all user specific scripts are derived. Also, the script store and the user profiles store may include interfaces for communicating remotely with the interactive response system.

In a further alternative embodiment the variable automated response system includes a plurality of interactive response systems and respective script stores.

In a second aspect the present invention provides an interactive response system comprising a receiver; an analyser for identifying sounds received by the receiver, script means for accessing user specific scripts from a script store; a program memory in which is stored instructions for identifying a caller and for accessing a scrip specific to an identified caller; and reproduction means for reproducing audibly the user specific script.

In a third aspect the present invention provides an interactive response program comprising a set of instructions for identifying a caller; accessing a user specific script on the basis of the identity of the caller; and reproducing the user specific script audibly.

In a fourth aspect the present invention provides a method of supplying telephonic information to a caller comprising the steps of identifying a caller; accessing a user specific script on the basis of the identity of the caller; and reproducing the user specific script audibly.

In a fifth aspect the present invention provides a script editor comprising a user interface; a forms store in which one or more forms to be displayed to a user are stored; a program memory containing instructions for recording data entered into one or more forms by a user via the user interface and for generating a user specific script in dependence on said recorded data.

In a sixth aspect the present invention provides a script amendment program comprising a set of instructions for supplying one or more forms to a user interface; recording data entered by a user onto the one or more forms; and generating a user specific script for use by an interactive response system on the basis of the data entered by the user onto the one or more forms.

In a seventh aspect the present invention provides a method of generating a user specific script for use in an interactive response system, comprising the steps of supplying one or more forms to a user interface; recording data entered by a user onto the one or more forms; and generating a user specific script on the basis of the data entered by the user onto the one or more forms.

With th present invention a user is able to customise the behaviour of the automated response system for interactions specifically with the user. In particular, with the present invention, the user is able to restrict or omit irrelevant exchanges of communication with the automated response system.

Reference herein to a voice portal is intended as reference to any telephony-based automated response system which provides access for the user to information and/or transactions from a single dialled telephone number.

Embodiments of the present invention will now be described by way of example with reference to the accompanying drawings, in which:

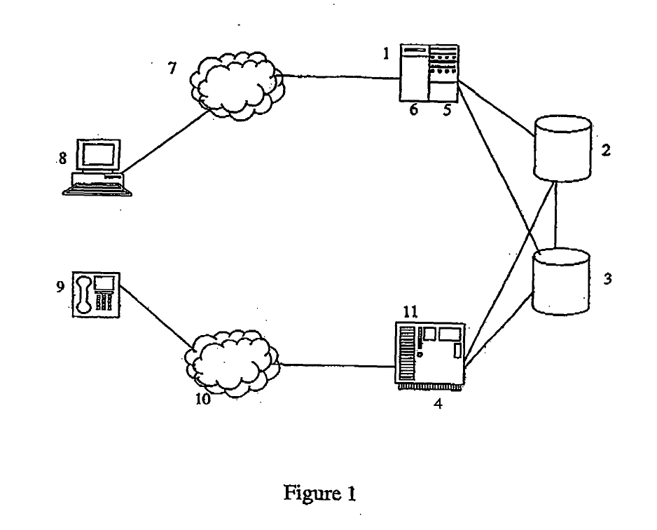

FIG. 1 illustrates a system architecture implementing a variable automated response system according to the present invention;

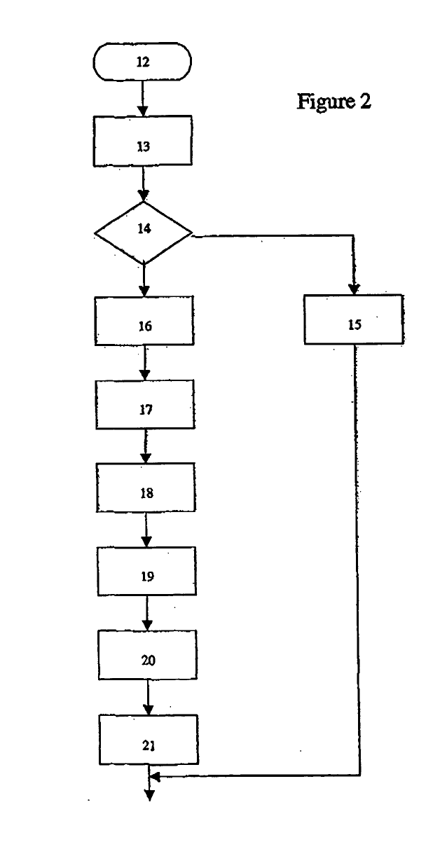

FIG. 2 is a diagram of the steps followed in the enrolment of a new user on the variable automated response system of FIG. 1;

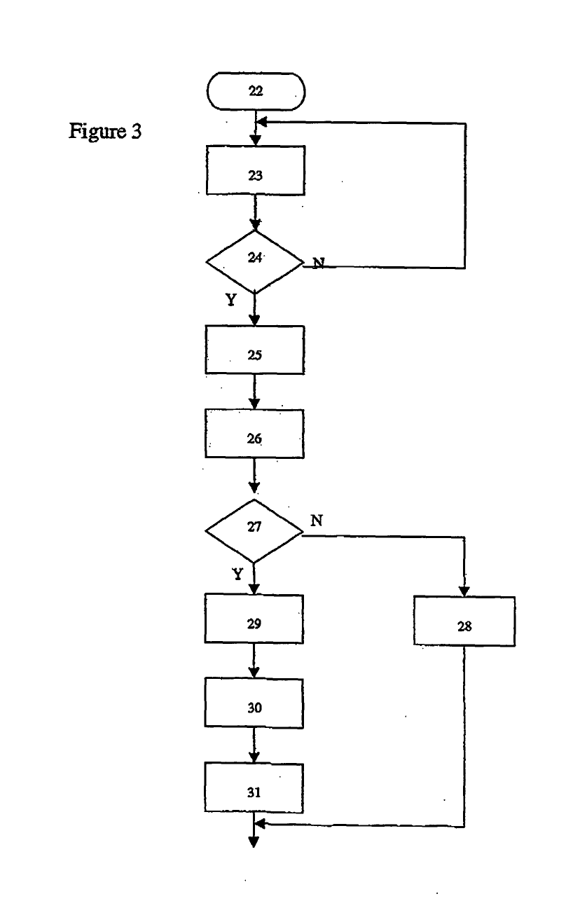

FIG. 3 is a diagram of the steps followed in amendment of an existing user script; and

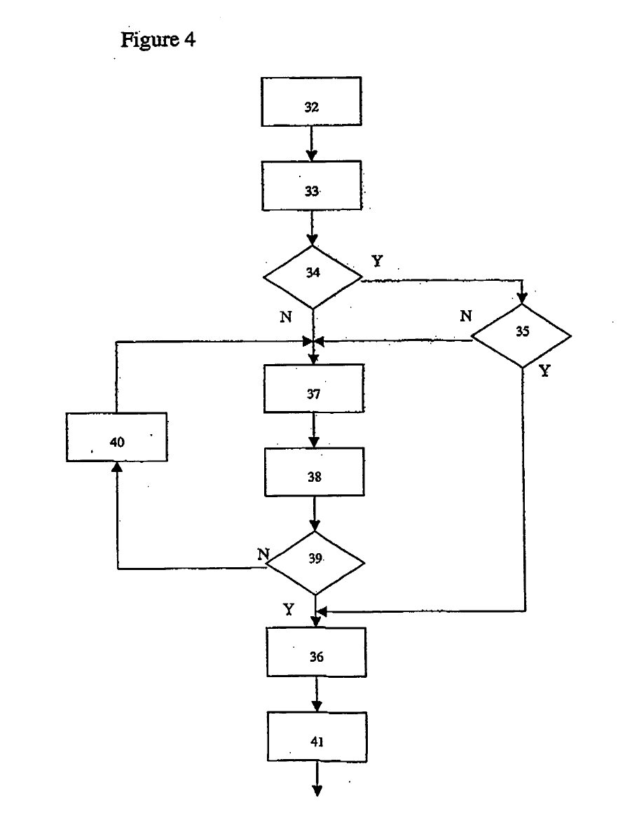

FIG. 4 is a diagram of the steps followed when a user telephones an interactive voice response system in accordance with the present invention.

One system architecture for a variable automated response system is shown in FIG. 1 and consists primarily of a voice portal personalisation (VPP) controller 1, a scripts store 2, a user profiles store 3 and an interactive voice response (IVR) server 4. Ideally, the VPP controller 1 includes program memory 5 in which is stored a suite of programs which consist of the instructions for controlling the manner in which the customisation requirements of a user are obtained and recorded. Although the program memory 5 is illustrated as part of the controller 1 it will be immediately apparent that the program may be hosted on a separate server which communicates with the VPP controller. The VPP controller 1 is also the host server for the customisation pages which are stored in a forms store and are used when a user is identifying their customisation requirements. The controller 1 presents the customisation pages to users on demand and the suite of programs processes any data input by the user, initiates database searches, updates and writes VPP scripts (as will be described in greater detail below) and dynamically generates web pages containing individual user information. The VPP controller 1 further includes a communications interface 6 for enabling the VPP controller to communicate over the Internet 7, for example, with a user. The user may employ a personal computer 8 for communicating with the VPP controller 1. However, alternative electronic systems having a graphical user interface (GUI) such as a personal organisers and WAP-enabled telephones may alternatively be employed by the user.

The scripts store 2 and the user profiles store 3 consist generally of memory in which predefined user data is stored. The scripts store 2 and the user profiles store 3 may form part of the VPP controller 1, in a similar manner to that of the program memory 5, or the stores may be at separate locations on the Internet which are accessible to the controller. The contents of the two stores are described in greater detail below.

The IVR server 4 hosts the voice portal service and has a communications interface which enables the IVR server 4 to communicate with the scripts store 2 and the user profiles store 3 and with a user's telephone 9 via a conventional telephony system 10 such as a public switched telephone network (PSTN) or a private branch exchange (PBX). The IVR server 4 includes or has access to program memory 11 in which is stored the instructions for implementing a user's customised interaction when the user contacts the IVR server by telephone.

The VPP controller 1 works by allowing users of the IVR system to fill in and/or modify standard Hypertext Mark-up Language (HTML) or related mark-up language (e.g. XML, DHTML, VXML) forms, which shall be referred to a customisation pages, on a World Wide Web site accessible via the Internet. On the customisation pages, users are invited to supply or modify information that is unique to them (.g. name, contact details) and, at enrolment only, are issued with a unique user account number and personal identity number (PIN). During a session using the customisation pages, users may set parameters from a list presented to them, specifying elements of the IVR server's 4 overall behaviour. These parameters may define such things as: which voice the system should speak with, the interpersonal style of the interaction, the extent to which the system should prompt the user with things they may say or do at decision points in the dialogue, the extent to which the system should seek confirmation before finalising transactions, and other similar features of overall IVR server behaviour. In addition, by selecting or deselecting check boxes or similar devices in the customisation pages, users may select dialogue elements which they wish to include in IVR sessions or exclude from them. They may also specify an ordering between some or all of the elements they have selected for inclusion in dialogues, to determine the order in which these elements are presented to the user in IVR dialogues.

At the end of a session using the customisation pages, the user is required to click on a web page button or link to confirm their chosen customisation settings. When the button or link is clicked, the available information and customisation preferences are submitted, using standard HTML (or derivative) methods of form processing to pass the information via Common Gateway Interface (CGI) protocols to a separate computer program (the ‘VPP program’ which is stored in the program memory 5), whose name and stored location are specified in the source text of the customisation pages. This VPP program may be implemented in Perl, Java, C, C++, ActiveX, or any CGI-addressable computer programming language. The VPP program consists of a set of instructions for generating a declarative text file (the ‘VPP script’), structured with mark-up tags, which is unique for each user, and which will subsequently serve as the script to be followed by the IVR server for interactions via the telephone with that particular user only. The VPP program uses the information passed from the customisation pages to select and order el ments from its store of predefined text blocks for inclusion in the VPP script. Each of these text blocks defines how the IVR server 4 should behave for some element of its dialogues with the user. The VPP script may be written as a declarative text file, using any structured text mark-up language, including, but not restricted to, STML, HTML, XML, VXML, or a purpose-designed scheme. It may optionally be compiled into a machine code executable.

The VPP program stores the VPP script file to a file store location, the script store 2, which, as mentioned above, may be accessible locally or over a network. The script store 2 may be in the form of a directory on a file server connected to the IVR server 4 or the controller 1 or the VPP script file for a particular user may be stored with a unique universal resource locator (URL) anywhere on the Internet. The VPP program also makes or updates an entry, in the form of the user's profile, in a database, the VPP user database, which is accessible to the IVR server 4 in the user profiles store 3. The profile entered in the VPP user database records the user's account number and PIN, the user's telephone number(s) if it/they have been entered on the customisation pages, plus any other information relating to the user that has been entered on the customisation pages. Most importantly, it specifies the address at which that user's unique VPP script has been stored in the script store 2.

When a user telephones and is connected to the IVR server 4, the server's first task is to identify the caller. It may do this either by prompting the user to input their account number and PIN, or by the conventional telephony technique of calling line identification to find the caller's telephone number. The account number+PIN or calling number is used as a key to search the VPP user database. Failure to find a matching profile in the VPP user database triggers another attempt at caller identification, caller rejection, or the following of a generic IVR script, according to the IVR system's set-up options. If a matching profile is found in the VPP user database, the address of the caller's stored VPP script is retrieved. The IVR server reads the VPP script from this address in the script store 2 and proceeds with the IVR dialogue session, based on the information and instructions contained in that caller's unique VPP script.

With the variable automated response system described above, each user of the IVR system can use web-based forms to customise the behaviour of the IVR server to their own needs and preferences Moreover, once a VPP script has been generated for a user it may be amended at any time by the user through the customisation pages of the controller 1.

What happens in a call to the IVR server 4 which offers a voice portal service based on the VPP methodology depends on the range of services offered in the customisation pages and how the user has customised their account. Below is an illustrative example of a customised script.

| | |
|---|---|
| Portal: | Good afternoon, Jennifer. |
| | In the City the FT100 is down 54.3 points to 6372.6 on |
| | fears of US interest rate rises. |
| | Sharewatch: Widget Group down 3.5 to 321 p. Pinco up 2 at |
| | 25 p. |
| | Cricket: In the third test against Zimbabwe, England |
| | opened the batting and is currently 51 for 2. |
| | You have two emails; would you like to review them? |
| User: | Yes. |
| Portal: | Email from Anthony Smith, subject: ‘Sorry’. Listen to |
| | message? |
| User: | No, delete it. |
| Portal: | Delete this message? |
| User: | Yes. |
| Portal: | Email from Norman Fraser, subject: Meeting on Thursday. |
| | Listen to message? |
| User: | Yes. |
| Portal: | Dear Jennifer, I'm looking forward to seeing you in our |
| | London office at 11 o'clock on Thursday. Don't forget to |
| | bring your latest growth projections. Norman. |
| | Delete, Store, Repeat or Reply? |
| User: | Store. |
| Portal: | Message stored. You have no more email messages, and no |
| | faxes. Please choose another service or hang up to end the |
| | call. |
| User. | Shopping. |
| Portal: | What type of shop do you require? |
| User: | A florist. |
| Portal: | Would you like me to put you through to Flowers By |
| | Phone? |
| User: | Yes. |
| Portal: | Please hold while I transfer you . . . |
| | [Call is transferred to a call centre.] |

The above is purely an illustrative example. The IVR system could behave in superficially quite different ways for other users, depending on their personal preference settings. For example, users could customise any one or more of the following:

The way the voice portal greets them.

The voice portal's general level of verbosity or terseness.

Which classes of actions require confirmation (e.g. message deletions in the above example) and which do not.

The information the voice portal should always offer without being asked and the order in which it should be presented.

The services the user will never be interested in.

As mentioned earlier, these preferences could be reset at any time via the web site which includes the customisation pages.

The IVR system could also behave in superficially quite different ways for other voice portal services depending on the range and type of services offered and a wide variety of services could be offered via a voice portal of this kind. For example, the features of a voice portal-service based on the VPP methodology could include, but not be restricted to, some or all of the following:

### Information Services

News headlines, weather bulletins, stock quotes, stock market regulatory news service, sports bulletins/results, cinema/theatre programmes, tides, traffic and travel, flight information, TV and radio schedules.

### Communications Services

Email access, voice browsing of web pages, fax receipt (a fax receipt agent will receive faxes, read them out over the telephone, and forward them to any number requested), voice dialling (users could set up a phonebook allowing them to say things like ‘call the office’, have the portal look up the number from their user profile, dial the call, and put them through), personal numbering (callers will be issued with their own personal telephone number, which they can use as a single point of contact for people trying to reach them; they can request calls to their personal number to be forwarded to any number using the voice portal service. Includes voice mail.), teleconferencing, international calling (low cost long distance calling), dictation service (agents will take dictation over the telephone and email the result either to the user or to a specified party), memo (users can store voice memos for themselves), diary/calendar (users access their web-bas d calendar over the telephone).

### Partnership Services

Talking Pages™, shopping (based on partnerships with telephone shopping service call centres), bulletin boards (listen to contributions to web bulletin boards on the telephone, e.g. investment bulletin boards), telephone banking/financial services, chat room access.

### Entertainment/Lifestyle Services

Streaming audio/video conceits, sporting events, jokeline™, braintease™, justice line (audio petition hosting), charity campaigns (e.g. front-end for pledges), personality interface (using the voices of e.g., Basil Fawlty, Marilyn Monroe).

When the VPP voice portal service is called from a Wireless Application Protocol (WAP) phone, spoken information could be augmented with visuals (e.g. share price graphs), and possible speech menu choices could be listed at each point in the dialogue to help users find their way through the service.

In the illustrative dialogue appearing above, the user's call is transferred. It will of course be apparent that this facility may be extended so that the voice portal service automatically connects to other external, services. For example, the voice portal service could be used to obtain information on films currently showing at a particular cinema and, having selected a film of interest, to automatically e-purchase tickets for the film.

FIG. 2 represents the procedure followed by the variable automated response system illustrated in FIG. 1. The user, using any Internet browsing system 8, accesses 12 via the internet 7 the VPP customisation pages from the controller 1. The customisation pages require essential and optional information to be entered 13 by the user including personal information such as the user's name and address, the user's telephone number, e-mail address and credit or debit card details. With the information entered by the user, the controller 1 checks whether the user is already enrolled with th system by searching 14 the VPP user database. Where the user is already enrolled, the controller 1 displays 15 a message to the user that they cannot enrol a second time for the identical personal information and asking whether they wish to alter their existing customisation of the IVR system. Where the user is new, the user's preferences (customisation selection) are collected 16 using additional customisation pages that are displayed in turn to the user. The controller 1 then assigns 17 a unique account number and PIN number to the user and generates 18 a VPP script file for the user based on their personal information and the preferences entered by the user. The VPP script file is then stored 19 in the script store 2 and the storage address is recorded in a user profile which is stored 20 in the VPP user database. The user profile contains, in addition to the storage address of the user's VPP script file, their account number, their PIN number, their personal information including the user's telephone number and any voice portal preferences (e.g. the type of voice, verbosity etc to be used). Finally, the user is informed 21 of the account number and PIN number that has been assigned to them and also the telephone number the user is to ring to access the voice portal. This information may be supplied separately via e-mail.

As mentioned earlier, an existing user can after their preferences at any time via the customisation pages of the variable automated response system. FIG. 3 is a diagram of the steps taken where a user wishes to alter their existing customisation of the IVR system. Via the Internet, the user connects 22 to the controller 1 and the controller 1 prompts the user for their account number and PIN in a login web page 23. The controller 1 then checks 24 whether the data entered by the user corresponds to a user profile stored in the VPP profile database. If the controller 1 is unable to find a match the user is prompted to try to login again. If a match is found, the details of the user's profile are displayed 25 in the first of the customisation pages and the user is invited to make whatever alterations are required. Subsequent customisation pages showing the existing preferences of the user are then displayed 26 and the user is invited to make whatever alterations are desired. The controller 1 then checks 27 whether any changes have been made to any of the customisation pages. Where no changes have been made, the user is advised 28 that no changes will be recorded. Where the controller 1 detects changes to the customisation pages, the controller 1 generates 29 a new VPP script based on the user's personal information and their preferences. The existing VPP script for that user is then overwritten 30 with new VPP script and where changes have been made to the user's personal information the user profile is also updated. The user is then informed 31 that the records have been updated.

With reference to FIG. 4, once a user has registered their preferences with the variable automated response system, as described above, telephone calls to the interactive voice response system will reflect the user's preferences in the following manner. The user dials 32 the voice portal telephone number that has been supplied to the user previously. The IVR system 4 answers 33 the call and checks whether it is able to identify 34 the users telephone number. Where the telephone number is identified, the system checks 35 whether a user profile can be identified in the VPP profile database from the telephone number. If a user profile is found, it is retrieved and from the profile the user's VPP script is accessed from the script store 2. Where the telephone number cannot be recognised or a user profile cannot be identified from the telephone number, the controller 1 prompts the user for their account number 37 and collects the user's reply using tone dialing or speech recognition. The controller 1 then prompts the user for their PIN number 38 and similarly collects the user's reply using tone dialing or speech recognition. The controller 1 then checks 39 whether it is possible to identify a user profile form the account number and the PIN number. If a user profile cannot be identified, the user is advised 40 that the account number and/or the PIN number have not b en recognised. Where a user profile is identified, then the user's VPP scrip is accessed 36 from the script store. Once a VPP scrip has been accessed, the IVR system follows the customised script 41, subject to the user's input choices, during the rest of the telephone call.

The above variable automated response system has been described in combination with an associated interactive voice response system. However, it is envisaged that the variable automated response system could incorporated more than one interactive voice response system. A user could be supplied with different telephone numbers to different interactive voice response systems which offer different services or information but which will follow the same customised interaction with the user that the user stored as their preferences. For example, one IVR system could specifically provide shopping information whereas a second, separate IVR system could provide automated communication with a bank. Ideally, this is achieved by a separate VPP scripts being generated for each separate IVR system based on a single input of the user's preferences. Each VPP script is then identified with reference to the particular IVR system it is intended for and the relevant script is accessed by the IVR system when as user's profile is identified.

Also, although the IVR systems have been described above with reference to their active as voice portals, it will be apparent that the variable automated response system could also be implemented with more conventional interactive voice response systems, for example to reduce the number of options recited to a regular customer in an automated telephonist system.

Although reference has been made exclusively to a user communicating with the VPP controller 1 via the internet, it is envisaged that other means of communication may be employed for example via a private network or an Intranet.

It will be apparent that the details of the system architecture and the particular method of interaction between a user and the variable automated response system could be altered without departing from the main features of the variable automated response system being the provision of one or more forms in which user preferences can be entered which are used in the generation of a user specific customised script that is employed in all subsequent communications between that user and an interactive telephone system.

1. A variable automated response system comprising a user interface; a forms store in which one or more forms to be displayed to a user are stored; a program memory containing instructions for recording data entered into one or more forms by a user via the user interface and for generating a user specific script in dependence on said recorded data; a script store in which a plurality of user specific scripts are stored; and an interactive response system for accessing and reproducing audibly a script in dependence on the user accessing the interactive response system.

2. A variable automated response system as claimed in claim 1, further including a user profiles store containing data on a plurality of users in relation to user identification data and script identification data.

3. A variable automated response system as claimed in claim 2, wherein the user identification data includes a user's telephone number.

4. A variable automated response system as claimed in claim 3, wherein the interactive response system includes caller identification means for identifying a caller by means of the telephone number they are calling from.

5. A variable automated response system as claimed in any one of the preceding claims, wherein the script store includes a default script from which all user specific scripts are derived.

6. A variable automated response system as claimed in any one of the preceding claims, wherein the script store and the user profiles store include interfaces for communicating remotely with the interactive response system.

7. A variable automated response system as claimed in any one of the preceding claims, including a plurality of interactive response systems and respective script stores.

8. An interactive response system comprising a receiver; an analyser for identifying sounds received by the receiver; script means for accessing user specific scripts from a script store; a program memory in which is stored instructions for identifying a caller and for accessing a scrip specific to am identified caller; and reproduction means for reproducing audibly the user specific script.

9. The interactive response system as claimed in claim 8, further including caller identification means for identifying a caller by means of the telephone number they are calling from.

10. An interactive response program comprising a set of instructions for identifying a caller, accessing a user specific script on the basis of the identity of the caller; and reproducing the user specific script audibly.

11. A method of supplying telephonic information to a caller comprising the steps of identifying a caller; accessing a user specific script on the basis of the identity of the caller; and reproducing the user specific script audibly.

12. A script editor comprising a user interface; a forms store in which one or more forms to be displayed to a user are stored; a program memory containing instructions for recording data entered into one or more forms by a user via the user interface and for generating a user specific script in dependence on said recorded data.

13. A script amendment program comprising a set of instructions for supplying one or more forms to a user interface; recording data entered by a user onto the one or more forms; and generating a user specific script for use by an interactive response system on the basis of the data entered by the user onto the one or more forms.

14. A method of generating a user specific script for use in an interactive response system, comprising the steps of supplying one or more forms to a user interface; recording data entered by a user onto the one or more forms; and generating a user specific script on the basis of the data entered by the user onto the one or more forms.

15. A method as claimed in claim 14, further including the step of accessing a default script and amending the default script in accordance with the data entered by the user.
